(19) United States
(12) Patent Application Publication
(10) Pub. No.: US 2013/0241213 A1
(43) Pub. Date: Sep. 19, 2013

(54) LOCKING SYSTEM

(71) Applicant: Thomas Warren Cox, Bloomington, IL (US)

(72) Inventor: Thomas Warren Cox, Bloomington, IL (US)

(73) Assignee: NAVISTAR DEFENSE ENGINEERING, LLC, Lisle, IL (US)

(21) Appl. No.: 13/606,884

(22) Filed: Sep. 7, 2012

Related U.S. Application Data
(60) Provisional application No. 61/534,740, filed on Sep. 14, 2011.

(51) Int. Cl. E05C 3/12

(52) U.S. Cl. CPC E05C 3/12
USPC 292/4

(57) ABSTRACT

A system and method for locking and unlocking separate access doors of a vehicle using a single movement, is disclosed. The locking system includes a sliding member, a primary rotating lever coupled to the sliding member, a secondary rotating lever operably connected to the primary rotating lever through a plurality of linkages, and at least two pivotal latches positioned at separate access areas of the vehicle and operably connected to the linkages, wherein a single movement of the sliding member rotates primary and secondary rotating levers to pivot the latches simultaneously between an engaged position and a disengaged position at the separate access areas.

### CROSS-REFERENCE TO RELATED APPLICATIONS

This application claims the benefit of U.S. Provisional Patent Application Ser. No. 61/534,740 filed on Sep. 14, 2011.

### TECHNICAL FIELD

The present system and method relates to locking and unlocking an access area of a vehicle. More specifically, the system and method relates to a locking system such that simultaneous locking and unlocking of multiple access areas or doors on the vehicle can be accomplished through a single motion from a single location within the vehicle.

### BACKGROUND

Mine-resistant, ambush protected vehicles (MRAP) are commonplace in today's military arsenal. These vehicles often include multiple access areas for exiting and entering the vehicle, for example, driver and passenger side and/or rear doors. Each access door is equipped with its own set of locks, often referred to as combat locks, for securing and unsecuring the doors. Furthermore, each set of locks on each door requires individual operation. However, during specific events, it may be necessary to have the ability to lock or unlock all of the access doors from a single location in a single motion.

The present disclosure provides a locking/unlocking system and method for operating different, opposing access area doors in a single motion. Specifically, the present system permits activating all of the locks on multiple access doors from a single location. This means that any crew member can operate all of the locks using a single motion, from one location on each side of the vehicle, which provides enhanced safety and operation of the system to secure and unsecure the vehicle. This system and method may be necessary under certain circumstances and especially with reduced crew.

### SUMMARY

There is disclosed herein an improved system and method for locking and unlocking multiple access area or doors of a vehicle in a single motion, which avoids the disadvantages of prior systems while affording additional structural and costs advantages.

Generally speaking, the present system and method relates to a locking system, which in a single motion, is capable of locking and unlocking multiple doors of a vehicle.

In an embodiment, the locking system comprises a sliding member, a primary rotating lever coupled to the sliding member, a secondary rotating lever operably connected to the primary rotating lever through a plurality of linkages, and at least two pivotal latches positioned at separate access areas of the vehicle and operably connected to the linkages, wherein a single movement of the sliding member rotates primary and secondary rotating levers to pivot the latches simultaneously between an engaged position and a disengaged position at the separate access areas.

In another embodiment, a locking system for simultaneously locking and unlocking separate access doors of a vehicle, is disclosed. The lock system comprises a sliding member at a single location, a primary rotating component coupled to the sliding member, a secondary rotating component operably connected to the primary rotating component through a plurality of linkages, and a pivotal latch positioned at each separate access door of the vehicle, wherein a single movement of the sliding member rotates the primary and secondary rotating components through the linkages to pivot the separate latches simultaneously between a locked position and an unlocked position at the separate access doors.

A method for simultaneously locking and unlocking separate access doors on a vehicle, is disclosed. In an embodiment, the method comprises the steps of providing a sliding member at a single location, coupling a primary rotating lever to the sliding member, coupling a plurality of secondary rotating levers to the primary rotating lever through a series of linkages, providing separate pivotal latches at separate access doors of the vehicle, moving the sliding member laterally to rotate the primary and secondary rotating levers through the linkages pivoting the latches simultaneously to lock and unlock the separate access doors.

These and other features and advantages of the locking system and method can be more readily understood from the following detailed discussion with reference to the appended drawing figures.

### BRIEF DESCRIPTION OF THE DRAWINGS

FIG. 1 is a perspective view of an embodiment of the present locking system;

FIG. 2 is a perspective view of an embodiment of the present locking system in an unlocked position; and,

FIG. 3 is a perspective view of an embodiment of the present locking system in a locked position.

### DETAILED DESCRIPTION

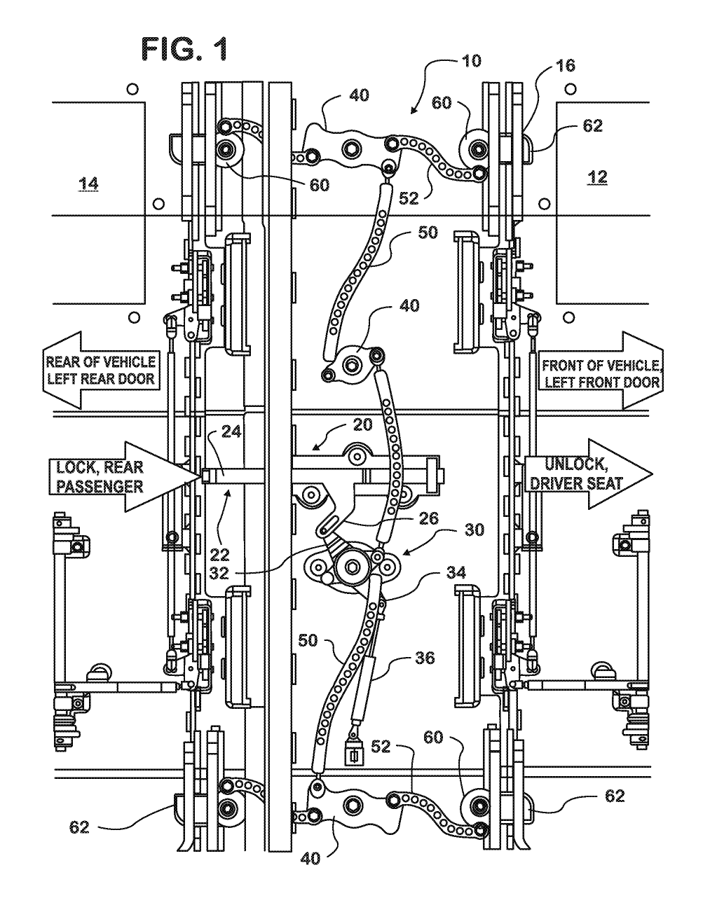

Referring to FIGS. 1-3, there is illustrated an embodiment of the locking system generally designated by the numeral 10, as well as the components thereof. The present locking system is useful in a vehicle (not shown), including a military vehicle, having multiple access areas or doors. Previously, each access area or door included its own separate locking system, which required individual operation. The present locking system permits a vehicle occupant or crew member to simultaneously lock and unlock the doors, regardless of the number of doors, from a single location using a single motion.

FIG. 1 illustrates an embodiment of the locking system 10. The locking system is located generally in the middle section of a vehicle, between the front driver door 12 and the rear passenger doors 14. The locking system 10 comprises a sliding member 20 positioned at a height for convenient operation, for example, midway of the height of the corresponding doors. The sliding member 20 generally includes a handle 22 with a hand grip portion 24 and an engagement portion 26 for coupling with the primary rotating component or lever 30, as will be described. In operation, the handle 20 slides in a linear or lateral direction, as shown by the arrows in FIG. 1, resulting in locking or unlocking of the doors in a single movement.

The engagement portion 26 of the handle couples with a corresponding portion of the primary rotating component or lever 30. Specifically, the engagement portion couples with a first arm 32 of the rotating lever 30. A second arm 34 opposing the first arm of the rotating lever engages a biasing member 36, for example, a spring-loaded piston. During operation, the handle 20 is slid laterally, rotating the primary lever 30 through the biasing member 36, which locks the handle in place until the handle is slid in the opposing direction.

Sliding the handle 20 transmits movement from the primary lever 30 to a secondary rotating component or lever 40. The secondary rotating lever 40 is operably connected to the primary rotating lever 30 through a plurality of linkages 50. As shown the in figures, the present embodiment of the locking system 10 includes three secondary locks. However, it should be understood that the number of secondary rotating levers 40 can vary considerably, depending on the number and positioning of the pivotal latches or locks 60 associated with the doors.

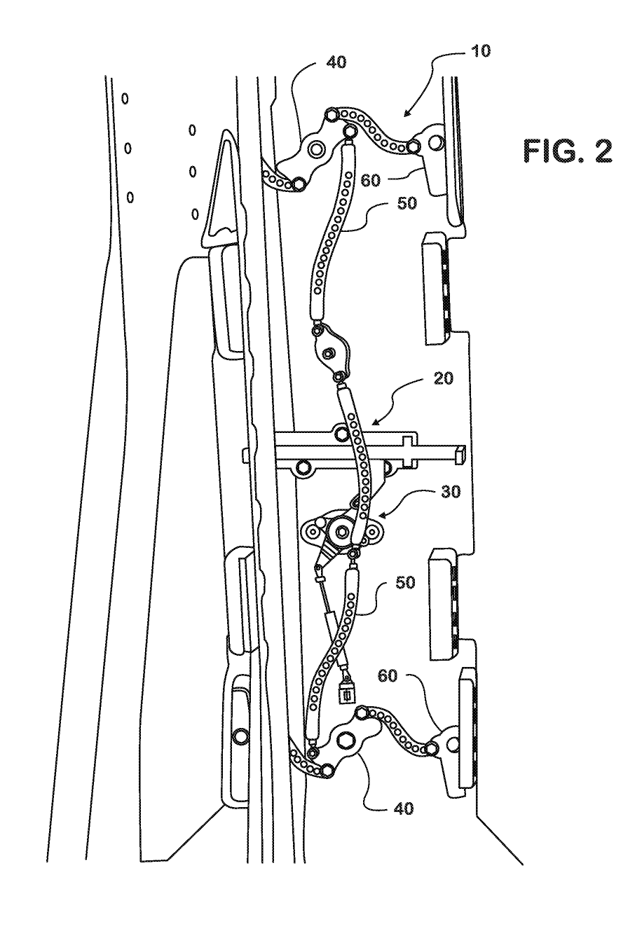

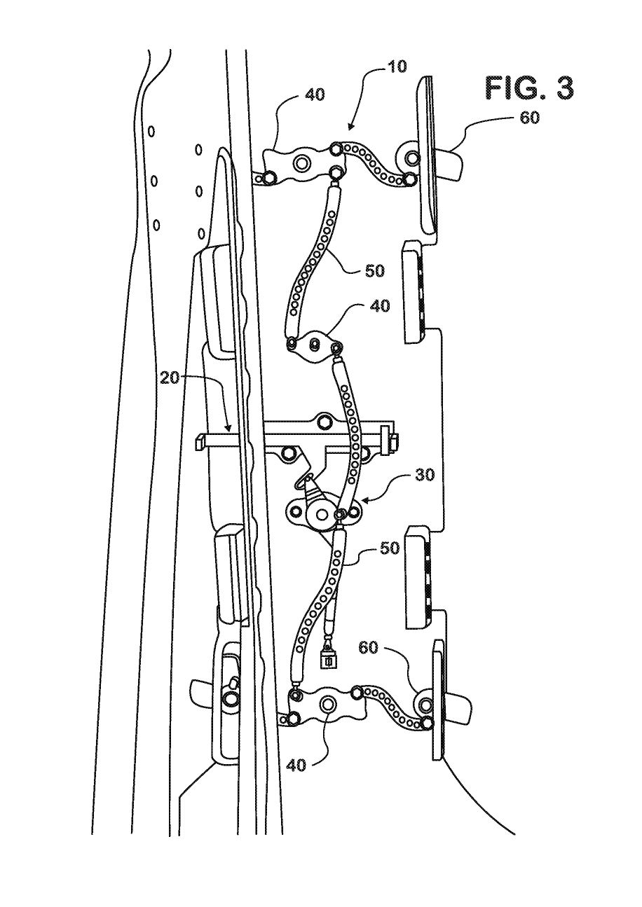

Each door includes at least an upper and a lower pivotal latch or lock 60. The lock 60 includes an engagement portion 62, which, when the system is in the “locked” or engaged position, the engagement portion is received within at least one slot 16 of the door 12, 14, thereby securing the door in the locked position (FIGS. 1 and 3). When the lock 60 is pivoted to the “unlocked” or disengaged position, the engagement portion 62 of the lock is pivoted downward to disengage from the slot (FIG. 2). As mentioned, it is the initial single sliding movement of the handle 20 to rotate the primary lever 30, which in turn moves the linkages and 50 and the secondary levers 40 to rotated the locks 60 from an engaged to a disengaged and back again position.

The present system 10 is useful in a method for simultaneously locking and unlocking separate access doors on a vehicle. Under certain situations, including where crew numbers may be reduced, it would be useful to operate the locking and unlocking of access doors on each side of a vehicle from a single location by one crew member. The present method includes laterally moving the handle 20 between a first position and a second position, which rotates the primary lever 30, which in turn, moves the linkages 50. The linkages 50 are operably connected to the secondary levers 40, which rotate to move secondary linkages 52 directly connected to the pivoting latches or locks 60. The locks 60 pivot between a locked position with a slot of the door, to an unlocked position outside of the door slot. This method permits simultaneous locking or unlocking, for example, the driver's side door and rear passenger door of the vehicle.

What is claimed is:

1. A locking system for a vehicle having separate access areas, the locking system comprising:
a sliding member;
a primary rotating lever coupled to the sliding member;
a secondary rotating lever operably connected to the primary rotating lever through a plurality of linkages; and,
at least two pivotal latches positioned at separate access areas of the vehicle and operably connected to the linkages, wherein a single movement of the sliding member rotates primary and secondary rotating levers to pivot the latches simultaneously between an engaged position and a disengaged position at the separate access areas.

2. The locking system of claim 1, wherein the slidable member is a handle.

3. The locking system of claim 2, wherein the handle is accessible from a single location.

4. The locking system of claim 1, wherein the system includes a plurality of secondary rotating levers.

5. The locking system of claim 1, wherein the access areas include a driver side door and a rear passenger door.

7. A locking system for simultaneously locking and unlocking separate access doors of a vehicle, the lock system comprising:
a sliding member at a single location;
a primary rotating component coupled to the sliding member;
a secondary rotating component operably connected to the primary rotating component through a plurality of linkages; and,
a pivotal latch positioned at each separate access door of the vehicle, wherein a single movement of the sliding member rotates the primary and secondary rotating components through the linkages to pivot the separate latches simultaneously between a locked position and an unlocked position at the separate access doors.

8. The locking system of claim 7, wherein the primary rotating component includes a main lever.

9. The locking system of claim 7, wherein the secondary rotating components includes a plurality of secondary levers.

10. A method for simultaneously locking and unlocking separate access doors on a vehicle, the method comprising the steps of:
providing a sliding member at a single location;
coupling a primary rotating lever to the sliding member;
coupling a secondary rotating lever to the primary rotating lever through a series of linkages;
providing separate pivotal latches at separate access doors of the vehicle; and,
moving the sliding member laterally to rotate the primary and secondary rotating levers through the linkages pivoting the latches to simultaneously to lock and unlock the separate access doors.

11. The method of claim 10, wherein the secondary rotating levers includes a plurality of rotating levers.

12. The method of claim 10, wherein the method further includes the step of coupling the secondary rotating levers to the latches through a second set of linkages.

13. The method of claim 10, wherein the method further includes the step of locking the primary rotating lever between an engaged position and a disengaged position using a biasing member.
